(19) United States
(12) Patent Application Publication
(10) Pub. No.: US 2016/0253583 A1
(43) Pub. Date: Sep. 1, 2016

(54) PRINTING WITH A COMBINATION OF FIXED FONTS AND PROPORTIONAL FONTS

(71) Applicant: TOSHIBA TEC KABUSHIKI KAISHA, Tokyo (JP)

(72) Inventor: Noriaki Harada, Sunto (JP)

(21) Appl. No.: 14/633,234

(22) Filed: Feb. 27, 2015

(51) Int. Cl. G06K 15/02

(52) U.S. Cl. CPC G06K 15/1827

(57) ABSTRACT

In accordance with the embodiment, a printer comprises a communication section configured to receive character data from a host, an image buffer configured to store the character data received by the communication section, a character generator configured to include font data which corresponds to the character data uniquely, and a control section configured to read, from the character generator, the font data corresponding to the character data read from the image buffer and generate a character string.

### FIELD

Embodiments described herein relate generally to a printer provided with a font that is a combination of a fixed font and a proportional font.

### BACKGROUND

Conventionally, a printer, which is provided with both the fixed font of which the pitches are equal and the proportional character of which the character width varies according to the category of the characters, such as a POS (Point Of Sales) system desired to be newly used to cope with the Arabia characters has been considered. In such a POS, in a case of printing the data containing both Arabia characters and alphanumeric characters on a receipt and the like, the item names are printed in proportional font of Arabia character and the price and the like are printed in fixed font of alphanumeric character. In this printing process, the Arabia characters can be printed without being extended and the digits of the prices can be aligned. However, an application side needs to send a command to the printer to switch between the fixed font and the proportional character.

Further, in a case of a printer which merely copes with either of the fixed font or the proportional font, the Arabia characters are shrunk or extended and the digits of the prices are not aligned. In order to obtain desired print output, the application needs to create image data to be output and send the created image data to the printer as a bit image.

However, a change of the application including a switch command is needed to switch between the fixed font and the proportional font. Even if the application is changed, there is a problem that the switch between the fixed font and the proportional font cannot be carried out in a case in which the memory capacity of the printer is small and there is no condition for carrying both the fixed font and the proportional font for all the characters.

### BRIEF DESCRIPTION OF THE DRAWINGS

FIG. 1 is a diagram illustrating the conceptual system constitution of a printer according to one embodiment;

FIG. 2 is a diagram illustrating a print example in which Arabia characters are printed in proportional font and alphanumeric characters are printed in fixed font;

FIG. 3 is a diagram illustrating a print example in which the Arabia characters and the alphanumeric characters are printed in proportional font;

FIG. 4A is a diagram illustrating the constitution of general printer font data;

FIG. 4B is a diagram illustrating the constitution of printer font data according to the embodiment; and

FIG. 5 is a diagram illustrating an example of a printing processing based on character data of fixed pitch and proportional pitch.

### DETAILED DESCRIPTION

In accordance with the embodiment, a printer comprises a communication section configured to receive character data from a host, an image buffer configured to store the character data received by the communication section, a character generator configured to include font data which corresponds to the character data uniquely, and a control section configured to read, from the character generator, the font data corresponding to the character data read from the image buffer and generate a character string.

Hereinafter, embodiments are described in detail with reference to the accompanying drawings.

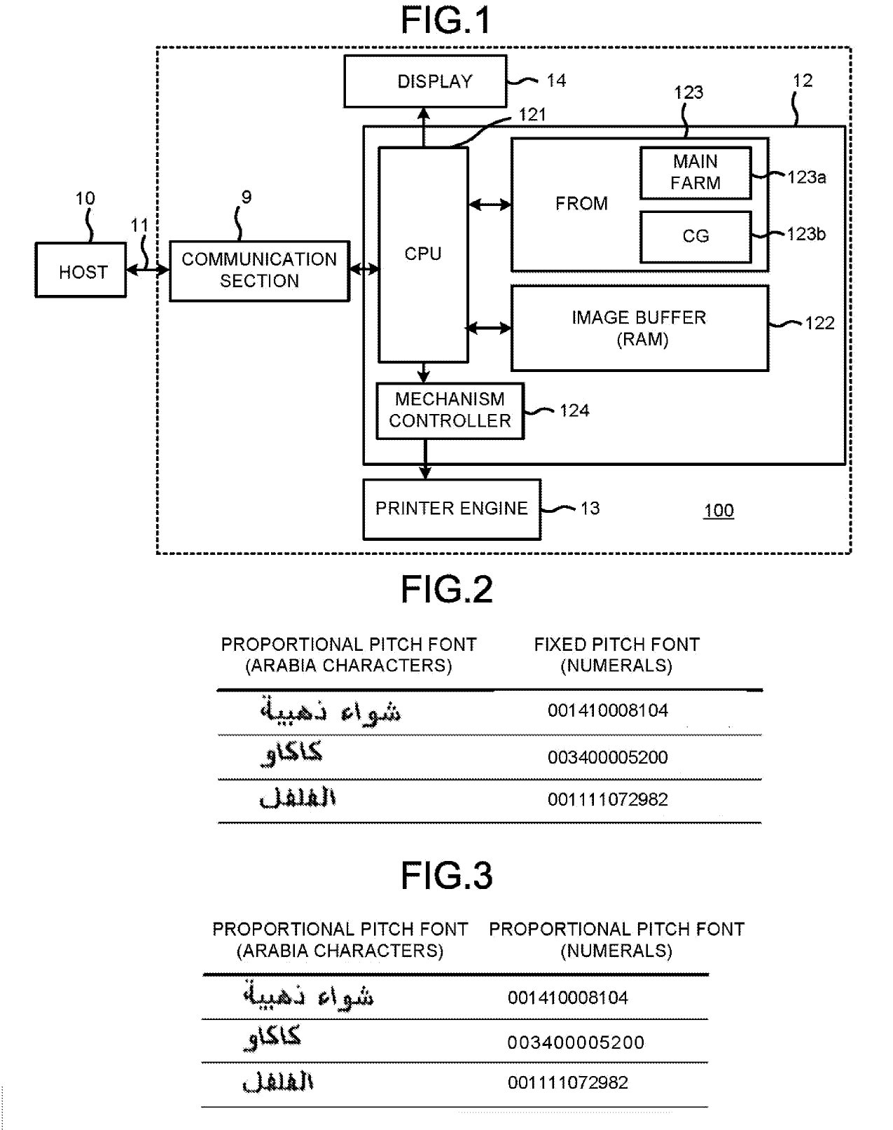

FIG. 1 is a diagram illustrating the conceptual system constitution of the printer according to the embodiment.

In FIG. 1, a numeral 100 indicates the printer, and a numeral 10 indicates a host computer serving as a print requesting source which sends character data and a control command to the printer 100. The printer 100 and the host 10 are connected with each other through a USB (Universal Serial Bus) cable 11. The host 10, which is, for example, a PC (Personal Computer), can send a print command and character data to the printer 100. The printer 100 consists of a communication section 9, a control section 12, a printer engine 13, a display 14 and the like.

The communication section 9 carries out communication between, for example, the printer 100 and the host 10 which is arranged outside and is managed by a user and the like. The printer 100 receives the character data sent from the host 10 through the communication section 9.

The control section 12 consists of a CPU (Central Processing Unit) 121, an image buffer 122, a FROM (Flash Read Only Memory) 123 including areas of a main farm 123a, a character generator (CG) 123b and the like, a mechanism controller 124 and the like.

The CPU 121 carries out various processing in the printer 100. The CPU 121 is further in charge of the execution of the firmware stored in the main farm 123a and the reading of the font data stored in the character generator 123b.

The image buffer 122, which is, for example, a RAM (Random Access Memory), stores the character data and the like temporarily.

Various parameters used in the operation control of the printer 100 and the content relating to the registration of the printer 100 are stored in the FROM 123. The main farm 123a of the FROM 123 has a function of controlling the entire printer 100.

The main farm 123a has a function of reading the font data from the character generator 123b in which the font data and the like are stored. The character generator 123b includes the font data which corresponds to the character data uniquely. The font data is the proportional font and the fixed font.

The mechanism controller 124 controlled by the CPU 121 drives the printer engine 13 which carried out printing based on the character data read from the character generator 123b. The printer engine 13 consists of a carriage (not shown) which carries a print head for printing the character string generated by the control section 12 on a medium and carries out horizontal scanning, a conveyance mechanism for conveying a sheet, and the like.

The recording device for storing various programs is not limited to the FROM 123. For example, an optical DVD (Digital Versatile Disc) or a magnetic HDD may be used as other storage medium. Further, for example, an electrical SSD (Solid State Device) and the like may be considered.

FIG. 2 is a diagram illustrating a print example in which Arabia characters are printed in proportional font and alphanumeric characters are printed in fixed font. FIG. 3 is a diagram illustrating a print example in which both the Arabia characters and the alphanumeric characters are printed in proportional font. The print example of the alphanumeric characters shown in FIG. 2 and FIG. 3 only include numerals.

In FIG. 2, the character string of the Arabia characters is printed in proportional font of normal cursive writing in which the character width varies for each character, and the character string of the numerals is printed in fixed font in which the character width is the same. In this case, the numerals are printed at a fixed pitch having an equal width, thus, the digits are aligned even if a plurality of numerals are arrayed. In this way, as the digits of the numerals are aligned, it is easy to confirm the amount in a state in which the numerals are printed on a recording medium such as a receipt of the POS.

In FIG. 3, similar to FIG. 2, the Arabia characters are printed in proportional font of normal cursive writing. The numerals are also printed in proportional font, and for example, the character pitches of “0” and “1” are different from each other. That is, in the character strings in which the numerals are printed in proportional font, the digits of the numerals are not aligned.

In this way, the Arabia characters are normal characters printed in proportional font in which the character width varies for each character. However, in a case in which the alphanumeric characters are printed in proportional font, the character width varies according to the characters. In a receipt and the like of a POS on which a sales amount is printed, the amount is likely to be misperceived in a case in which the digits are not aligned due to the numerals having different character widths.

The data of the Arabia character does not contain line feed LF and carriage return CR. That is, the carriage return CR information for retracting the carrier of paper and the line feed LF information for newline are not contained. Thus, the print of the sent character data is simply as shown in FIG. 2.

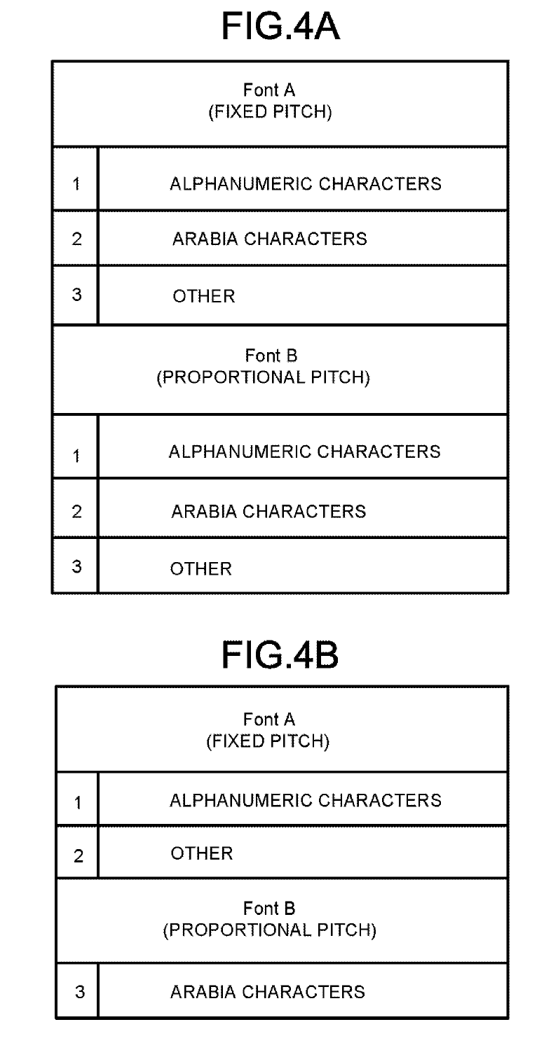

In the present embodiment, constitution is changed from the printer font data constitution of a general POS shown in FIG. 4A to the printer font data constitution shown in FIG. 4B.

In FIG. 4A, as a font A, the alphanumeric character, the Arabia character and other are set to fixed pitch; as a font B, the alphanumeric character, the Arabia character and other are set to proportional pitch. In a case of printing a receipt of the POS in font A, the print result is in a state shown in FIG. 3. The Arabia characters are normal characters, while the digits of the numerals are not aligned, which leads to the problem described above.

In a case of printing a receipt of the POS in font B, the print result is in a state shown in FIG. 2. The Arabia characters are normal characters, and the digits of the numerals are aligned. An operator needs to switch between the font A and the font B shown in FIG. 4A according to a command.

However, there is a printer in which the original application side is not provided with a command for switching between the fixed pitch font and the proportional font. In a case of a printer that uses the application provided with no command for switching between the fixed pitch font and the proportional font, it is necessary to switch to an application provided with a command by the user.

In FIG. 4B, as a font A, the alphanumeric character and other are set to fixed pitch; as a font B, the Arabia character is set to proportional pitch. In this case, the numerals are printed as character data at a fixed pitch while the Arabia characters are printed as character data at a proportional pitch. Thus, in a case of printing a receipt of the POS in font A and font B, the print result is in a state shown in FIG. 2. The Arabia characters are normal characters and the digits of the numerals are aligned.

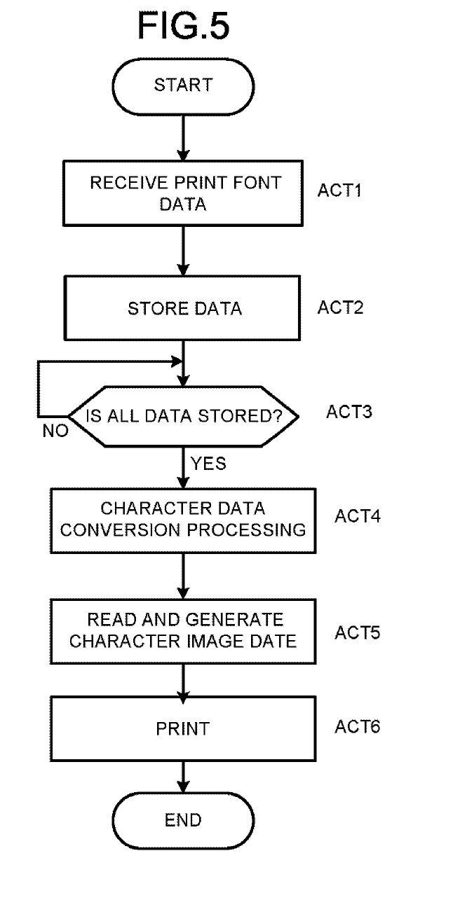

Herein, an example in which the Arabia characters and the numerals in the first line in FIG. 2 are printed on a receipt based on the print font data in FIG. 4B is further described together with the flowchart shown in FIG. 5.

The control section 12 receives the print font data in FIG. 4B sent from the host 10 through the USB cable 11 (ACT 1).

The received printer font data is temporarily stored in the image buffer 122 (ACT 2).

As to the stored character data, it is determined whether or not all the data to be printed this time is stored (ACT 3).

If it is determined in ACT 3 that all the data is stored (YES in ACT 3), a character data conversion processing is carried out according to the stored character data sequentially (ACT 4).

The character data conversion processing is a processing for rearranging, for example, the Arabia character font and numerals font in the line direction so that the character data is as the Arabia character and numerals in the first line in FIG. 2. The control section 12 stores the rearranged character data in the image buffer 122.

The control section 12 reads the image data of the Arabia character and the numerals based on the character data of the first line from the character generator 123b to generate the character string (ACT 5).

Sequentially, the control section 12 drives the printer engine through the mechanism controller 124 to print the Arabia characters in proportional font and the numerals at fixed pitch on the receipt (ACT 6).

In this way, the Arabia characters are in proportional font and the alphanumeric characters are in fixed font. Then it is set to read an Arabia character code in a case of Arabia characters and read an alphanumeric character code in a case of alphanumeric characters. In this way, there is no need to switch between the proportional pitch and the fixed pitch according to the command from the application.

Further, the proportional font and the fixed pitch font are switched with a command. In this case, it is necessary to contain the character data of each font as the character data. Thus, a corresponding memory capacity is needed. However, in a case in which the Arabia characters are equipped with the proportional font, and the alphanumeric characters and other are equipped with the fixed font, there is no need to send a command and it is possible to reduce the memory capacity.

In the present embodiment, it is applicable even if the application side does not send the command for distinguishing the fixed pitch font and the proportional font. Further, the font data size of the printer can be reduced, and it is possible to cope with the problem even with the machine of which the memory capacity for storing the font is small.

In each embodiment described above, the printer 100 and the host 10 are connected with each other through the USB cable 11; however, a system in which the printer 100 and the host 10 are arranged integrally may be used. Further, the correspondence relation between the character data and the font data may be changed from the host 10.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

1. A printer comprising:
a communication section configured to receive character data from a host;
an image buffer configured to store the character data received by the communication section;
a character generator configured to identify alphanumeric characters and non-alphanumeric characters of the character data and generate fixed font data for the alphanumeric characters and proportional font data for the non-alphanumeric characters; and
a control section configured to read, from the character generator, the fixed font data and proportional font data corresponding to the character data read from the image buffer and generate a character string with fixed font alphanumeric characters and proportional font non-alphanumeric characters.

2. (canceled)

3. The printer according to claim 1, wherein the non-alphanumeric characters correspond to Arabia characters.

4-5. (canceled)

6. The printer according to claim 1, further comprising:
a print head configured to print the character string generated by the control section on a medium.

7. The printer according to claim 6, wherein the medium is a receipt.

8. The printer according to claim 1, wherein the end of the line of the non-alphanumeric character data sent from the host contains line feed information.

9. The printer according to claim 1, wherein the end of the line of the non-alphanumeric character data sent from the host contains carriage return information.

10. The printer according to claim 1, wherein the correspondence relation between the character data and the font data can be changed from the host.

11. A method of printing characters, comprising:
storing, in an image buffer, character data received from a host;
identifying, from the image buffer, alphanumeric characters and non-alphanumeric characters of the character data and generating fixed font data for the alphanumeric characters and proportional font data for the non-alphanumeric characters;
generating a character string from the fixed font data and the proportional font data; and
printing the generated character string on a medium, wherein the character string includes fixed font alphanumeric characters and proportional font non-alphanumeric characters.
